(19) United States
(12) Patent Application Publication
(10) Pub. No.: US 2026/0006550 A1
(43) Pub. Date: Jan. 1, 2026

(54) COMPUTING POWER RECONFIGURATION METHOD AND RELATED APPARATUS

(71) Applicant: HUAWEI TECHNOLOGIES CO., LTD., Shenzhen (CN)

(72) Inventors: Zhe Liu, Shanghai (CN); Chenghui Peng, Shanghai (CN); Jun Wang, Shanghai (CN); Fei Wang, Shanghai (CN); Huanhuan Huang, Shanghai (CN); Mingyu Zhao, Shanghai (CN)

(73) Assignee: HUAWEI TECHNOLOGIES CO., LTD., Shenzhen (CN)

(21) Appl. No.: 19/320,212

(22) Filed: Sep. 5, 2025

Related U.S. Application Data
(63) Continuation of application No. PCT/CN2023/080325, filed on Mar. 8, 2023.

(51) Int. Cl. H04W 52/02; H04W 36/00

(52) U.S. Cl. CPC H04W 52/0222; H04W 36/0011

(57) ABSTRACT

receiving an acknowledgment message for the CE configuration message from the target access network device, and receiving an acknowledgment message for the CE reconfiguration or deletion message from the first core network element. According to embodiments of this application, continuity of computing task execution can be implemented in a cell handover scenario.

### CROSS-REFERENCE TO RELATED APPLICATIONS

This application is a continuation of International Application No. PCT/CN2023/080325, filed on Mar. 8, 2023, the disclosure of which is hereby incorporated by reference in its entirety.

### TECHNICAL FIELD

This application relates to the field of communication technologies, and in particular, to a computing power reconfiguration method and a related apparatus.

### BACKGROUND

An existing wireless network mainly provides a connection service, and a wireless network architecture mainly resolves a connection service problem between terminals or between a terminal and a server. With emergence of new scenarios and new requirements such as artificial intelligence (AI) in future wireless networks, in addition to providing the connection service, the wireless network further needs to provide a computing service (namely, a computing power service) and a service in which computing power and a connection are comprehensively considered.

This application mainly discusses how to ensure continuity of computing task execution when a terminal device and a radio access network (RAN) and/or a core network (CN) collaborate to complete a computing task and if a cell handover occurs on the terminal device.

### SUMMARY

This application provides a computing power reconfiguration method and a related apparatus, to ensure continuity of computing task execution in a cell handover scenario.

According to a first aspect, this application provides a computing power reconfiguration method. The method is performed by a CMF or a chip in the CMF. The method includes: obtaining computing power information of a target access network device and computing power information of a first core network element; sending a compute executor CE configuration message to the target access network device and sending a CE reconfiguration or deletion message to the first core network element based on the computing power information of the target access network device and the computing power information of the first core network element, to perform computing power reconfiguration of a first computing task; and receiving an acknowledgment message for the CE configuration message from the target access network device, and receiving an acknowledgment message for the CE reconfiguration or deletion message from the first core network element.

In this application, when a terminal device and a RAN and/or a CN collaborate to complete a computing task, if a cell handover occurs on the terminal device, the CMF may obtain the computing power information of the target access network device and the computing power information of the first core network element, and perform computing power redeployment based on the obtained computing power information, to migrate the computing task from a source access network device to the target access network device. According to the computing power reconfiguration method provided in this application, the computing task can be flexibly migrated, and quality of a computing service and continuity of computing task execution can be ensured after the cell handover occurs on the terminal device in a computing collaboration scenario.

In an embodiment, obtaining the computing power information of the target access network device includes: receiving a computing power update request from a session management function SMF, where the computing power update request includes the computing power information of the target access network device; or receiving a computing power update request from an access and mobility management function AMF, where the computing power update request includes the computing power information of the target access network device.

In an embodiment, the method further includes: sending a computing power update acknowledgment message to the SMF, where the computing power update acknowledgment message includes computing session information corresponding to a computing power reconfiguration result, the computing session information includes information about a destination CE and type information of the destination CE, and the computing session information is for releasing a computing context of the source access network device and/or a computing context of the first core network element; or sending a computing power update acknowledgment message to the AMF, where the computing power update acknowledgment message includes computing session information corresponding to a computing power reconfiguration result, the computing session information includes information about a destination CE and type information of the destination CE, and the computing session information is for releasing a computing context of the source access network device and/or a computing context of the first core network element.

In this embodiment, the CMF feeds back the computing session information corresponding to the computing power reconfiguration result, where the computing session information may be for releasing the computing context of the source access network device and/or the computing context of the first core network element. This facilitates timely resource reclamation.

In an embodiment, the type information of the destination CE includes a radio access network RAN type or a core network CN type.

In an embodiment, the computing power information of the target access network device includes at least one of the following information: a processor type of the target access network device, a processor capability of the target access network device, a processor occupancy status of the target access network device, and a deployment status of a computing task on the target access network device; and the computing power information of the first core network element includes at least one of the following information; a processor type of the first core network element, a processor capability of the first core network element, a processor occupancy status of the first core network element, and a deployment status of a computing task on the first core network element.

According to a second aspect, this application provides a computing power reconfiguration method. The method is performed by a target access network device or a chip in the target access network device. The method includes: sending a path switching request to an access and mobility management function AMF, where the path switching request includes computing power information of the target access network device; receiving a compute executor CE configuration message from a computing management function CMF, where the CE configuration message is for configuring computing power of a first computing task on the target access network device: and sending an acknowledgment message for the CE configuration message to the CMF.

In this application, the computing power information of the target access network device is carried in the path switching request, and the computing power information of the target access network device may be for computing power reconfiguration of the first computing task, so that continuity of computing task execution is implemented in a cell handover scenario.

In an embodiment, the method further includes: receiving a path switching acknowledgment message from the AMF, where the path switching acknowledgment message includes computing session information corresponding to a computing power reconfiguration result, and the computing session information includes information about a destination CE and type information of the destination CE; and releasing a computing context of a source access network device and/or a computing context of a first core network element based on the computing session information.

In this embodiment, the target access network device obtains the computing session information, and may release the computing context of the source access network device and/or the computing context of the first core network element based on the computing session information. This facilitates timely resource reclamation.

In an embodiment, the type information of the destination CE includes a radio access network RAN type or a core network CN type.

In an embodiment, the method further includes:
receiving a handover request from the source access network device, where the handover request includes computing service indication information, and the computing service indication information is for performing access control by the target access network device.

In an embodiment, the computing service indication information includes indication information of the first computing task, indication information of a service type, and indication information of a session type.

In an embodiment, the service type includes a stateful service or a stateless service, and the session type includes radio access network RAN termination or core network CN termination.

According to a third aspect, this application provides a computing power reconfiguration method. The method includes:

A computing management function CMF obtains computing power information of a target access network device and computing power information of a first core network element;
the CMF sends a compute executor CE configuration message to the target access network device and sends a CE reconfiguration or deletion message to the first core network element based on the computing power information of the target access network device and the computing power information of the first core network element, to perform computing power reconfiguration of a first computing task;
the target access network device sends an acknowledgment message for the CE configuration message to the CMF; and
the first core network element sends an acknowledgment message for the CE reconfiguration or deletion message to the CMF.

In an embodiment, the method further includes:
The target access network device sends a path switching request to an access and mobility management function AMF, where the path switching request includes the computing power information of the target access network device;
the AMF sends a computing session update request to a session management function SMF, where the computing session update request includes the computing power information of the target access network device; and
the SMF sends a computing power update request to the CMF, where the computing power update request includes the computing power information of the target access network device; and
that the CMF obtains the computing power information of the target access network device includes:
the CMF receives the computing power update request from the SMF.

In an embodiment, the method further includes:
The target access network device sends a path switching request to an AMF, where the path switching request includes the computing power information of the target access network device; and
the AMF sends a computing power update request to the CMF, where the computing power update request includes the computing power information of the target access network device; and
that the CMF obtains the computing power information of the target access network device includes:
the CMF receives the computing power update request from the AMF.

In an embodiment, the method further includes:
The CMF sends a computing power update acknowledgment message to the SMF, where the computing power update acknowledgment message includes computing session information corresponding to a computing power reconfiguration result, and the computing session information includes information about a destination CE and type information of the destination CE;
the SMF sends a computing session update acknowledgment message to the AMF, where the computing session update acknowledgment message includes the computing session information;
the AMF sends a path switching acknowledgment message to the target access network device, where the path switching acknowledgment message includes the computing session information, and the computing session information includes the information about the destination CE and the type information of the destination CE; and
the target access network device releases a computing context of a source access network device and/or a computing context of the first core network element based on the computing session information.

In an embodiment, the method further includes:
The CMF sends a computing power update acknowledgment message to the AMF, where the computing power update acknowledgment message includes computing session information corresponding to a computing power reconfiguration result, and the computing session information includes information about a destination CE and type information of the destination CE;
the AMF sends a path switching acknowledgment message to the target access network device, where the path switching acknowledgment message includes the computing session information, and the computing session information includes the information about the destination CE and the type information of the destination CE; and
the target access network device releases a computing context of a source access network device and/or a computing context of the first core network element based on the computing session information.

In an embodiment, the method further includes:
The source access network device sends a handover request to the target access network device, where the handover request includes computing service indication information: and the target access network device performs access control based on the computing service indication information.

In an embodiment, the computing service indication information includes indication information of the first computing task, indication information of a service type, and indication information of a session type.

In an embodiment, the service type includes a stateful service or a stateless service, and the session type includes radio access network RAN termination or core network CN termination.

According to a fourth aspect, this application provides a communication apparatus. The apparatus may be a CMF or a chip in the CMF. The apparatus includes:
a transceiver unit, configured to obtain computing power information of a target access network device and computing power information of a first core network element, where the transceiver unit is configured to: send a compute executor CE configuration message to the target access network device and send a CE reconfiguration or deletion message to the first core network element based on the computing power information of the target access network device and the computing power information of the first core network element, to perform computing power reconfiguration of a first computing task; and
the transceiver unit is configured to: receive an acknowledgment message for the CE configuration message from the target access network device, and receive an acknowledgment message for the CE reconfiguration or deletion message from the first core network element.

In an embodiment, when obtaining the computing power information of the target access network device, the transceiver unit is configured to:
receive a computing power update request from a session management function SMF, where the computing power update request includes the computing power information of the target access network device; or
receive a computing power update request from an access and mobility management function AMF, where the computing power update request includes the computing power information of the target access network device.

In an embodiment, the transceiver unit is further configured to:
send a computing power update acknowledgment message to the SMF, where the computing power update acknowledgment message includes computing session information corresponding to a computing power reconfiguration result, the computing session information includes information about a destination CE and type information of the destination CE, and the computing session information is for releasing a computing context of a source access network device and/or a computing context of the first core network element; or
send a computing power update acknowledgment message to the AMF, where the computing power update acknowledgment message includes computing session information corresponding to a computing power reconfiguration result, the computing session information includes information about a destination CE and type information of the destination CE, and the computing session information is for releasing a computing context of a source access network device and/or a computing context of the first core network element.

In an embodiment, the type information of the destination CE includes a radio access network RAN type or a core network CN type.

In an embodiment, the computing power information of the target access network device includes at least one of the following information: a processor type of the target access network device, a processor capability of the target access network device, a processor occupancy status of the target access network device, and a deployment status of a computing task on the target access network device; and
the computing power information of the first core network element includes at least one of the following information: a processor type of the first core network element, a processor capability of the first core network element, a processor occupancy status of the first core network element, and a deployment status of a computing task on the first core network element.

According to a fifth aspect, this application provides a communication apparatus. The communication apparatus may be a target access network device or a chip in the target access network device. The apparatus includes:
a transceiver unit, configured to send a path switching request to an access and mobility management function AMF, where the path switching request includes computing power information of the target access network device, where
the transceiver unit is configured to receive a compute executor CE configuration message from a computing management function CMF, where the CE configuration message is for configuring computing power of a first computing task on the target access network device; and
the transceiver unit is configured to send an acknowledgment message for the CE configuration message to the CMF.

In an embodiment, the apparatus further includes a processing unit, where
the transceiver unit is configured to receive a path switching acknowledgment message from the AMF, where the path switching acknowledgment message includes computing session information corresponding to a computing power reconfiguration result, and the computing session information includes information about a destination CE and type information of the destination CE; and
the processing unit is configured to release a computing context of a source access network device and/or a computing context of a first core network element based on the computing session information.

In an embodiment, the type information of the destination CE includes a radio access network RAN type or a core network CN type.

In an embodiment, the transceiver unit is further configured to:
receive a handover request from the source access network device, where the handover request includes computing service indication information, and the computing service indication information is for performing access control by the target access network device.

In an embodiment, the computing service indication information includes indication information of the first computing task, indication information of a service type, and indication information of a session type.

In an embodiment, the service type includes a stateful service or a stateless service, and the session type includes radio access network RAN termination or core network CN termination.

According to a sixth aspect, this application provides a communication system. The communication system includes a CMF and a target access network device. The CMF is configured to perform the method according to any one of the first aspect, and the target access network device is configured to perform the method according to any one of the second aspect.

In some embodiments, the communication system further includes a source access network device, and the source access network device is configured to perform the method performed by the source access network device in the third aspect.

In some embodiments, the communication system further includes a first core network element, and the first core network element is configured to perform the method performed by the first core network element in the third aspect.

In some embodiments, the communication system further includes an SMF, and the SMF is configured to perform the method performed by the SMF in the third aspect.

In some embodiments, the communication system further includes an AMF, and the AMF is configured to perform the method performed by the AMF in the third aspect.

According to a seventh aspect, this application provides a communication apparatus. The communication apparatus includes a processor, a transceiver, and a memory. The processor, the transceiver, and the memory are coupled. The memory stores a computer program. The processor and the transceiver are configured to invoke the computer program in the memory, to enable the communication apparatus to perform the method according to any one of the first aspect to the third aspect.

In an embodiment, the communication apparatus may be a chip that implements the methods in the first aspect to the third aspect or a device that includes the chip.

According to an eighth aspect, this application provides a communication apparatus. The communication apparatus includes a processor and an interface circuit, where the interface circuit is configured to receive a signal from a communication apparatus other than the communication apparatus and transmit the signal to the processor, or send a signal from the processor to a communication apparatus other than the communication apparatus: and the processor is configured to implement the method according to any one of the first aspect to the third aspect by using a logic circuit or by executing code instructions.

According to a ninth aspect, this application provides a computer-readable storage medium. The storage medium stores a computer program or instructions. When the computer program or the instructions are executed by a computer, the method according to any one of the first aspect to the third aspect is implemented.

According to a tenth aspect, this application provides a computer program product. When a computer reads and executes the computer program product, the computer is enabled to perform the method according to any one of the first aspect to the third aspect.

For beneficial effects of the fourth aspect to the tenth aspect, refer to beneficial effects of the first aspect and the second aspect. Details are not described herein again.

### BRIEF DESCRIPTION OF DRAWINGS

FIG. 1 is a diagram of an architecture of a communication system to which an embodiment of this application is applied;

FIG. 2 is a diagram of another architecture of a communication system to which an embodiment of this application is applied;

FIG. 3 is a diagram of a scenario of a MEC deployment position;

FIG. 4 is a diagram of an architecture of a control plane protocol stack to which an embodiment of this application is applied;

FIG. 5 is a diagram of another architecture of a control plane protocol stack to which an embodiment of this application is applied;

FIG. 6A and FIG. 6B are a schematic flowchart of a computing power reconfiguration method according to an embodiment of this application;

FIG. 7 is a diagram of a structure of a example communication apparatus according to an embodiment of this application; and

FIG. 8 is a diagram of a structure of a example communication apparatus according to an embodiment of this application.

### DESCRIPTION OF EMBODIMENTS

The following further describes in detail embodiments of this application with reference to the accompanying drawings.

In the specification, the claims, and the accompanying drawings of this application, terms such as “first” and “second” are used for distinguishing between different objects, but are not used for describing a specific sequence. In addition, terms “include”, “have”, and any other variants thereof are intended to cover a non-exclusive inclusion. For example, a process, a method, a system, a product, or a device that includes a list of operations or units is not limited to the listed operations or units, but optionally further includes an unlisted operation or unit, or optionally further includes another operation or unit inherent to the process, the method, the product, or the device.

“Embodiments” mentioned in the specification mean that specific features, structures, or characteristics described in combination with embodiments may be included in at least one embodiment of this application. The phrase shown in each position in the specification does not necessarily refer to a same embodiment, and is not an independent or alternative embodiment exclusive to another embodiment. It is explicitly and implicitly understood by a person skilled in the art that, embodiments described in the specification may be combined with another embodiment.

In this application, “at least one piece (item)” means one or more, “a plurality of” means two or more, “at least two pieces (items)” means two, three, or more, and “and/or” is used for describing an association relationship between associated objects and indicates that three relationships may exist. For example, “A and/or B” may indicate the following three cases: Only A exists, only B exists, and both A and B exist, where A and B may be singular or plural. The character “/” generally indicates an “or” relationship between the associated objects. “At least one item (piece) of the following” or a similar expression thereof means any combination of these items, including a singular item (piece) or any combination of a plurality of items (pieces). For example, at least one item (piece) of a, b, or c may indicate a, b, c, a and b, a and c, b and c, or a, b, and c, where a, b, and c may be singular or plural.

To better understand embodiments of this application, the following first describes a system architecture in embodiments of this application.

Technical solutions in embodiments of this application may be applied to various communication systems, such as a long term evolution (LTE) system, an LTE frequency division duplex (FDD) system, an LTE time division duplex (TDD) system, a 5th generation (5G) system like a new radio (NR) system, a system evolved after 5G like a 6th generation (6G) system, and a wireless local area network (WLAN). This is not limited herein.

It should be noted that, with maturity and popularization of 5G technologies, high-bandwidth and low-latency application services are gradually developing and mature on a terminal side. A 5G connection+edge computing convergence solution has become a goal pursued by major manufacturers. Multi-access edge computing (MEC) solutions defined in the European Telecommunications Standards Institute (ETSI) standard satisfy requirements of information providers (e.g., over the top (OTT) providers) for low-latency and high-throughput services at an edge.

FIG. 1 is a diagram of an architecture of a communication system to which an embodiment of this application is applied. As shown in FIG. 1, the communication system 1000 includes a radio access network 100 and a core network 200. In some embodiments, the communication system 1000 may further include an internet 300. In some embodiments, the communication system 1000 may further include a mobile/multi-access edge computing (MEC) network 400. The radio access network 100 may include at least one radio access network device (for example, 110a and 110b in FIG. 1), and may further include at least one terminal (for example, 120a, 120b, 120c . . . to 120j in FIG. 1). The terminal is connected to the radio access network device in a wireless manner, and the radio access network device is connected to the core network in a wireless or wired manner. A core network device and the radio access network device may be independent and different physical devices, or functions of the core network device and logical functions of the radio access network device may be integrated into a same physical device, or some functions of the core network device and some functions of the radio access network device may be integrated into one physical device. Mutual connections between terminals and between radio access network devices may be implemented in a wired or wireless manner. FIG. 1 is merely a diagram. The communication system may further include other network devices, for example, may further include a wireless relay device and a wireless backhaul device, which are not shown in FIG. 1.

The radio access network device is an access device accessed by the terminal to the communication system in a wireless manner. The radio access network device may be a base station, an evolved NodeB (eNodeB), a transmission reception point (TRP), a next generation NodeB (gNB) in a 5th generation (5G) mobile communication system, a next generation base station in a 6th generation (6G) mobile communication system, a base station in a future mobile communication system, an access node in a Wi-Fi system, or the like; or may be a module or a unit that completes some functions of the base station, for example, may be a central unit (CU), or may be a distributed unit (DU). The CU herein completes functions of a radio resource control protocol layer and a packet data convergence protocol (PDCP) layer of the base station. and may further complete functions of a service data adaptation protocol (SDAP) layer. The DU completes functions of a radio link control layer and a medium access control (MAC) layer of the base station. and may further complete some or all functions of a physical layer. For specific descriptions of the foregoing protocol layers, refer to related technical specifications of a 3rd generation partnership project (3GPP). The radio access network device may be a macro base station (for example, 110a in FIG. 1), or may be a micro base station or an indoor base station (for example, 110b in FIG. 1). or may be a relay node, a donor node, or the like. A specific technology and a specific device form that are used by the radio access network device are not limited in embodiments of this application. For ease of description, an access network device serves as a short name for the radio access network device, and the base station serves as an example of the radio access network device.

The terminal is a device having a wireless transceiver function, and may send a signal to the base station, or receive a signal from the base station. The terminal may also be referred to as a terminal device, UE, a mobile station, a mobile terminal, or the like. The terminal may be widely used in various scenarios, such as device-to-device (D2D), vehicle to everything (V2X) communication, machine-type communication (MTC), the internet of things (IoT), virtual reality, augmented reality, industrial control, autonomous driving, telemedicine, a smart grid, smart furniture, a smart office, a smart wearable, smart transportation, and a smart city. The terminal may be a mobile phone, a tablet computer, a computer having a wireless transceiver function, a wearable device, a vehicle, an airplane, a ship, a robot, a robotic arm, a smart home device, or the like. A specific technology and a specific device form that are used by the terminal are not limited in embodiments of this application.

The base station and the terminal may be at fixed positions or may be movable. The base station and the terminal may be deployed on the land, including an indoor or outdoor device, a handheld device, or a vehicle-mounted device; may be deployed on a water surface; or may be deployed on an airplane, a balloon, and an artificial satellite. Application scenarios of the base station and the terminal are not limited in embodiments of this application.

Roles of the base station and the terminal may be relative. For example, a helicopter or an unmanned aerial vehicle 120i in FIG. 1 may be configured as a mobile base station, and for a terminal 120j accessing the radio access network 100 through 120i, the terminal 120i acts as a base station. However, for a base station 110a, 120i acts as a terminal. In other words, communication between 110a and 120i is performed based on a radio air interface protocol. The communication between 110a and 120i may alternatively be performed based on an interface protocol between base stations. In this case, for 110a, 120i is also a base station. Therefore, both the base station and the terminal may be collectively referred to as communication apparatuses, 110a and 110b each in FIG. 1 may be referred to as a communication apparatus having a function of a base station, and 120a to 120j each in FIG. 1 may be referred to as a communication apparatus having a function of a terminal.

Communication between the base station and the terminal, between base stations, or between terminals may be performed by using a licensed spectrum, or may be performed by using an unlicensed spectrum, or may be performed by using both the licensed spectrum and the unlicensed spectrum. Communication may be performed by using a spectrum below 6 gigahertz. (GHz), or may be performed by using a spectrum above 6 GHZ, or may be performed by using both the spectrum below 6 GHZ and the spectrum above 6 GHZ. A spectrum resource used for wireless communication is not limited in embodiments of this application.

In embodiments of this application, a function of the base station may alternatively be performed by a module (for example, a chip) in the base station, or may be performed by a control subsystem including the function of the base station. The control subsystem including the function of the base station herein may be a control center in the foregoing application scenarios, such as a smart grid, industrial control, smart transportation, or a smart city. A function of the terminal may alternatively be performed by a module (for example, a chip or a modem) in the terminal, or may be performed by an apparatus including the function of the terminal.

In this application, the base station has the following convergence scheduling (CS) functions: determining whether computing data of an internal computing service is locally computed or routed to an in-network computing node; sensing a computing power status and reporting a sensing result; establishing, modifying, suspending, restoring, and releasing a heterogeneous resource of terminal computing power; computing power control; and computing radio bearer management. In a task architecture, CS is a part of task scheduling (TS) functions (where three elements of AI include computing power, algorithms, and data; in the task architecture, computing power, algorithms, data, and connections are managed and controlled in a unified manner; a computing management function mainly manages the computing power and the connections; and therefore, the CS may be considered as a part of the TS functions).

The base station sends a downlink signal or downlink information to the terminal. where the downlink information is carried on a downlink channel. The terminal sends an uplink signal or uplink information to the base station, where the uplink information is carried on an uplink channel. To communicate with the base station, the terminal needs to establish a wireless connection to a cell controlled by the base station. The cell that establishes the wireless connection to the terminal is referred to as a serving cell of the terminal. When communicating with the serving cell, the terminal is also interfered by a signal from a neighboring cell.

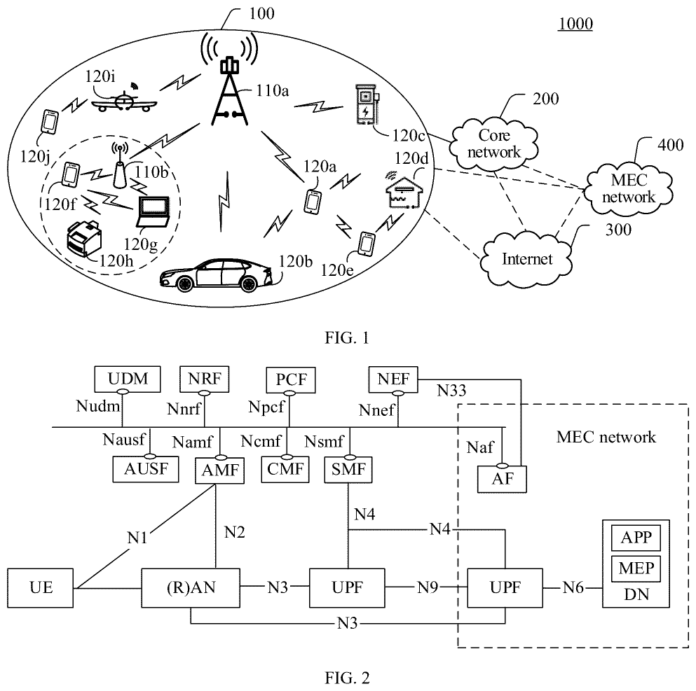

The MEC may be considered as a cloud server that runs at an edge of a mobile network and runs a specific task. The MEC defined by the ETSI is a platform that provides a capability that is based on an IT architecture and cloud computing for a user in a RAN network close to a mobile user. With reference to a 5G architecture defined in the 3GPP. an actual deployment position of the MEC in a wireless network usually corresponds to a local UPF network element in a 5G core network (for example, a UPF in a dashed box in a 3GPP 5G system architecture shown in FIG. 2). The local UPF network element implements local offloading and splitting of a service based on an N6 interface between the local UPF network element and a local data network (DN), to implement localized processing of the service and achieve acceleration effects.

FIG. 2 is a diagram of another architecture of a communication system to which an embodiment of this application is applied. The communication system is a system architecture in a 5G non-roaming scenario. As shown in FIG. 2, the communication system includes the following network functions and entities: a unified data management (UDM), a network repository function (NRF), a policy control function (PCF), a network exposure function (network exposure function, NEF), an authentication server function (AUSF), an access and mobility management function (AMF), a session management function (SMF), an application function (AF), UE, a (radio) access network ((R)AN), a user plane function (UPF), and a data network (DN).
1. User plane network element: The user plane network element serves as an interface with a data network, and completes functions such as user plane data forwarding, session/flow level-based charging statistics, and bandwidth throttling, namely, packet routing and forwarding, quality of service (QOS) processing of user plane data, and the like.

In a 5G communication system. the user plane network element may be a UPF network element.
2. Authentication server: The authentication server performs user security authentication. In the 5G communication system, the authentication server may be an AUSF network element.
3. Mobility management network element: The mobility management network element is mainly for mobility management, access management, and the like. In the 5G communication system, the mobility management network element may be an AMF network element, and mainly performs functions such as mobility management and access authentication/authorization. In addition, the mobility management network element is further responsible for transferring a user policy between a terminal and a PCF network element.
4. Session management network element: The session management network element is mainly for session management, allocation and management of an internet protocol (IP) address of user equipment, selection of a manageable user plane function, a termination point of a policy control and charging function interface, downlink data notification, and the like.

In the 5G communication system. the session management network element may be an SMF network element, and completes allocation of an IP address of a terminal, UPF selection, charging and QoS policy control, and the like.
5. Application network element: In the 5G communication system, the application network element may be an AF network element, indicates an application function of a third party or a carrier, is an interface for a 5G network to obtain external application data, and is mainly for transferring a requirement of an application side for a network side.
6. Unified data management network element: The unified data management network element is responsible for management of a user identifier, subscription data, authentication data, and registration management of a user service network element. In the 5G communication system, the unified data management network element may be a UDM network element.
7. Policy control network element: The policy control network element includes a user subscription data management function, a policy control function, a charging policy control function, QoS control, and the like, is configured to guide a unified policy framework for network behavior, provides policy rule information for a control plane function network element (for example, an AMF or SMF network element), and the like.

In the 5G communication system. the policy control network element may be a PCF.

8. Network function repository function network element: The network function repository function network element provides a storage function and a selection function of network functional entity information for another core network element. In the 5G communication system. the network element may be an NRF network element. 9. Network exposure network element: In the 5G communication system, the network exposure network element may be an NEF network element, is mainly for exposing a service and a capability of a 3GPP network function to an AF, and may also enable the AF to provide information for the 3GPP network function.

The foregoing function network element may be a network element in a hardware device, a software function running on dedicated hardware, or a virtualization function instantiated on a platform (for example, a cloud platform). One or more services may be obtained through division based on the foregoing function network element. Further, a service independent of the network function may exist. In this application, an instance of the foregoing function network element, an instance of a service included in the foregoing function network element, or an instance of a service that exists independently of the network function may be referred to as a service instance.

It should be learned that, in the 5G communication system. function network elements may have names of function network elements shown in FIG. 2. In a communication system (for example, a 6G communication system) evolved after 5G, the function network elements may still have the names of the function network elements shown in FIG. 2, or may have other names. For example, in the 5G communication system, the policy control network element may be a PCF. In the communication system (for example, the 6G communication system) evolved after 5G, the policy control function may still be the PCF, or may have another name. This is not limited in this application.

Nnef is a service-based interface exhibited by the NEF. Nnrf is a service-based interface exhibited by the NRF. Npcf is a service-based interface exhibited by the PCF. Nudm is a service-based interface exhibited by the UDM. Naf is a service-based interface exhibited by the AF. Nausf is a service-based interface exhibited by the AUSF. Namf is a service-based interface exhibited by the AMF. Nsmf is a service-based interface exhibited by the SMF. N1 is a reference point between the UE and the AMF. N2 is a reference point between the (R)AN and the AMF. N3 is a reference point between the (R)AN and the UPF. N4 is a reference point between the SMF and the UPF. N6 is a reference point between the UPF and the DN. N9 is a reference point between UPFs. N33 is a reference point between the NEF and the AF. It should be noted that, for meanings of Nnef, Nnrf, Npcf, Nudm, Naf, Nausf, Namf, Nsmf, N1, N2, N3, N4, N6, N9, and N33 in FIG. 2, refer to meanings defined in a related standard protocol. Details are not described herein.

As shown in FIG. 2, the AF, the UPF, and the DN may form a MEC network. The DN is a network located outside a carrier network. The carrier network may access a plurality of DNs. Application servers corresponding to a plurality of services may be deployed in the DN, to provide a plurality of example services for a terminal device. As shown in FIG. 2, the DN may include an application (APP) and a MEC platform (MEP).

In some embodiments, the CN may further include a function network element like a computing management function (CMF), and a service-based interface of the function network element may be Ncmf. The CMF has the following capabilities: computing power management. computing bearer management, and collaboration with the SMF to implement a connection and joint adjustment of a terminal to use a computing service of a base station or a core network through an air interface. In a task architecture, the CMF is a part of TA functions. Three elements of AI include computing power, algorithms, and data. In the task architecture, computing power, algorithms, data, and connections are managed and controlled in a unified manner. The computing management function mainly manages the computing power and the connection. Therefore, the CMF may be considered as a part of task anchor (TA) functions. In some embodiments, the CMF may alternatively be integrated with the SMF as function extension of the SMF, When the CMF is integrated with the SMF, signaling/message exchange between the CMF and the SMF in subsequent embodiments may be understood as an internal embodiment.

In addition, although not shown, the CN may further include another example network element.

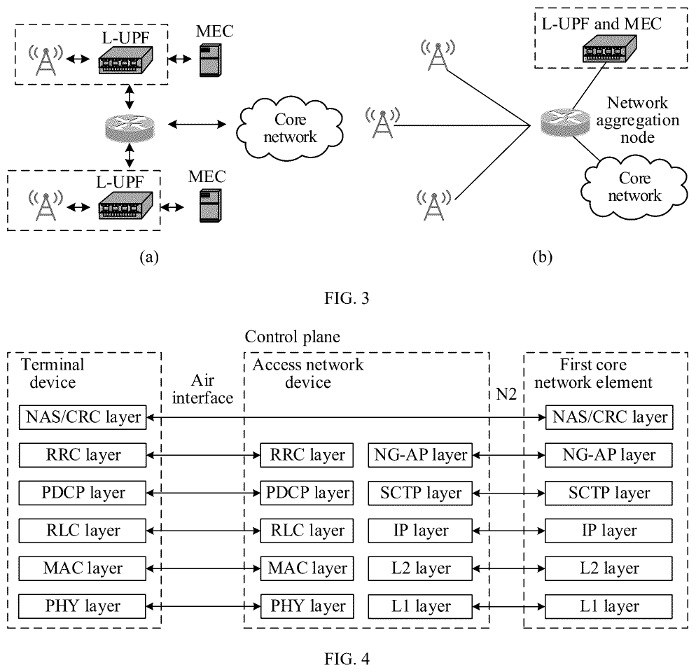

It may be understood that, MEC/an L-UPF implements service acceleration. Usually. the MEC/L-UPF may be co-deployed with a base station, or the MEC/L-UPF may be co-deployed with a network aggregation node, (a) in FIG. 3 is a diagram of a scenario in which the MEC/L-UPF is co-deployed with the base station, and (b) in FIG. 3 is a diagram of a scenario in which the MEC/L-UPF is co-deployed with the network aggregation node.

FIG. 4 is a diagram of an architecture of a control plane protocol stack to which an embodiment of this application is applied. As shown in FIG. 4, a control plane protocol stack between a terminal device and an access network device may include a non-access stratum (NAS), a computing resource control (CRC) layer parallel to the NAS layer, a radio resource control (RRC) layer, a packet data convergence protocol (PDCP) layer, a radio link control (RLC) layer, a medium access control (MAC) layer, and a physical layer (PHY). Control plane protocol layers between the access network device and a first core network element may include a next generation-application protocol (NG-AP) layer, a stream control transmission protocol (SCTP) layer, an internet protocol (IP) layer, a layer 2 (L2), and a layer 1 (L1). In some embodiments, the CRC layer may alternatively be a layer above the NAS layer, the RRC layer, or the NG-AP layer. In some embodiments, the CRC layer may alternatively be a layer parallel to the RRC layer or the NG-AP layer.

The CRC layer is above the RRC layer, and the terminal device, the access network device, and the first core network element all have the CRC layer.

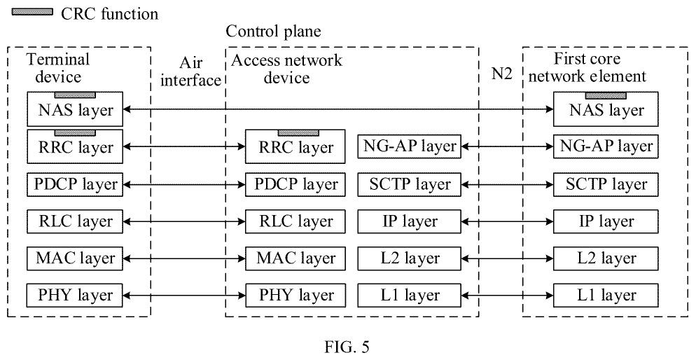

FIG. 5 is a diagram of another architecture of a control plane protocol stack to which an embodiment of this application is applied. As shown in FIG. 5, a control plane protocol stack between a terminal device and an access network device may include a NAS layer, an RRC layer, a PDCP layer, an RLC layer, a MAC layer, and a PHY layer. The NAS is a non-access stratum and is not processed or parsed by the access network device. The RRC layer, the PDCP layer, the RLC layer, the MAC layer, and the PHY layer form an access stratum. A CRC function may be an information element (IE) or an RRC container of the RRC layer. In some embodiments, the CRC function may alternatively be a function parallel to a function of the RRC layer, and is integrated with the RRC into xRC. In some embodiments, the CRC function may alternatively be an IE or a NAS container of the NAS layer, or the CRC function may be a function parallel to a function of the NAS layer, and is integrated with the NAS. In some embodiments, the CRC function may alternatively be an IE or a NAS container of an NG-AP layer, or the CRC function may be a function parallel to a function of the NG-AP layer, and is integrated with the NAS.

For ease of understanding of related content in embodiments of this application, the following describes some knowledge required for the solutions of this application. It should be noted that, these explanations are intended to make embodiments of this application easier to understand, but should not be construed as a limitation on the protection scope claimed in this application.

### 1. Computing Power

The computing power is a computing capability. The computing power is widely distributed on a cloud, an edge, an end, and an intermediate network element, and is integrated into a network. A computing power service, a connection service, and a service in which computing power and a connection are comprehensively considered all serve as basic services that can be provided by the network to the outside.

### 2. Computing Task

The computing task may be, for example, a task related to an application like AI (for example, AI inference or AI training), sensing, augmented reality (AR), industry control, holography, an internet of things (IOT), autonomous driving, a robot, an unmanned aerial vehicle, or a tactile internet.

Computing power may be for completing a computing task by using a computing resource, and the computing task is a representation form of a computing power application running in the computing resource. In embodiments of this application, the computing task may also be briefly described as a task, and one application may correspond to one or more tasks.

### 3. Resource

The resource may be, for example, a computing resource (including a central processing unit (CPU) and a memory), a storage resource (including a hard disk), or a network resource (including network bandwidth). Different nodes are allocated corresponding resources during execution of a computing task.

It should be noted that, an existing wireless network mainly provides a connection service, and a wireless network architecture mainly resolves a connection service problem between terminals or between a terminal and a server. With emergence of new scenarios and new requirements such as artificial intelligence (artificial intelligence, AI) in future wireless networks, in addition to providing the connection service, the wireless network further needs to provide a computing service (namely, a computing power service) and a service in which computing power and a connection are comprehensively considered.

### 4. Compute Executor (CE)

The CE (or described as a CE function) may use computing power configuration to perform computing execution, and complete a computing task. The CE function is a process of performing computation on an allocated computing resource. The CE function includes processes such as unified modeling and measurement of an underlying heterogeneous computing resource, unified conversion of a computing capability required for a computing task, reception of a unified interface call for a computing operation, computation, storage, and quantization processing based on an orchestrated serial/parallel computing manner and configured precision.

### 5. CN Termination and RAN Termination

A service being terminated at a CN node is CN termination, and a service being terminated at a RAN node is RAN termination.

### 6. Stateful Service and Stateless Service

The stateful service means that an instance of the service can back up some data at any time. In addition, when a stateful service is created, the data can be restored through the backup, to achieve data persistence. The stateful service can have only one instance. Therefore, “automatic service capacity adjustment” is not supported. Generally, a database service or an application that needs to store a configuration file or other persistent data on a local file system can create and use the stateful service.

The stateless service means that an instance of running of the service does not locally store data that needs to be persistent, and response results of a plurality of instances to a same request are completely consistent. After this type of service is created on the NetEase Honeycomb Cloud Platform, when a request for accessing the service reaches a service end, with internal load balancing of K8s, an instance is randomly found to complete a response to the request (which is currently in a polling manner). Instances of this type of service may be stopped or recreated due to some reasons (for example, during capacity expansion). In this case, all information (except logs and monitoring data) in the stopped instances is to be lost (when a container is restarted). Therefore. if important information needs to be retained in a container instance and is expected to be backed up at any time for future restoration. it is recommended to create a stateful service.

### 7. Cell Handover

In a process in which a terminal device camps on a current cell to perform a wireless service, the terminal device may gradually move to an edge position of the current cell due to mobility of the terminal device. In this case, signal strength at the edge position of the current cell is reduced due to a limited coverage area of the current cell. Consequently, signal quality of the current cell cannot satisfy a predetermined requirement, and a surrounding cell needs to be measured, to request a cell handover by reporting a measurement report to an access network device of the current cell.

It may be understood that, in embodiments of this application, a source access network device is an access network device corresponding to a cell that is accessed by the terminal device before the cell handover, and a target access network device is an access network device corresponding to a cell that is accessed by the terminal device after the cell handover.

This application mainly discusses how to ensure continuity of computing task execution when a terminal device and a RAN and/or a CN collaborate to complete a computing task and if a cell handover occurs on the terminal device. In other words, this application provides a computing power reconfiguration method and a communication apparatus, to ensure continuity of computing task execution in a cell handover scenario.

The following describes in detail the computing power reconfiguration method and the communication apparatus that are provided in this application.

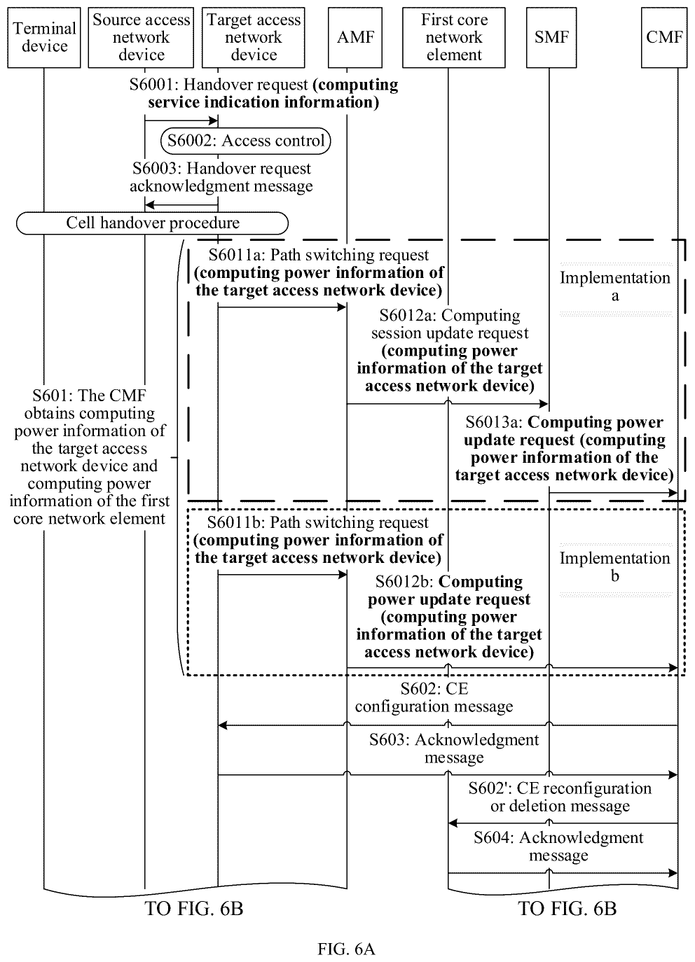

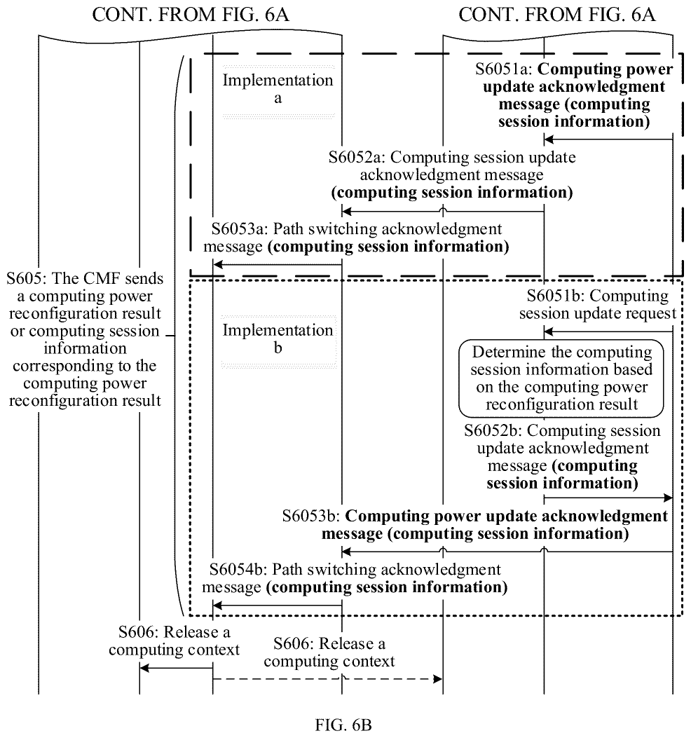

FIG. 6A and FIG. 6B are a schematic flowchart of a computing power reconfiguration method according to an embodiment of this application. As shown in FIG. 6A and FIG. 6B. the computing power reconfiguration method includes the following operation S601 to operation S6003. The method shown in FIG. 6A and FIG. 6B may be performed by a communication apparatus or a chip in the communication apparatus. The communication apparatus herein may be a CMF, an access network device (for example, a target access network device or a source access network device), or the like. It should be noted that. FIG. 6A and FIG. 6B are a schematic flowchart of a method embodiment of this application, and shows detailed communication operations or operations of the method. However, these operations or operations are merely examples. Other operations or variants of various operations in FIG. 6A and FIG. 6B may be further performed in embodiments of this application. In addition, the operations in FIG. 6A and FIG. 6B may be performed in a sequence different from that presented in FIG. 6A and FIG. 6B, and not all operations in FIG. 6A and FIG. 6B are performed.

S601: The CMF obtains computing power information of a target access network device and computing power information of a first core network element.

The computing power information herein is short for computing capability information. Computing power information of a device/network element may include information such as a processor type, a processor capability, a processor occupancy status, a memory occupancy status, and an electric quantity that are of the device/network element. This is not limited herein. The processor type may include a CPU, a graphics processing unit (GPU), and the like. This is not limited herein. For example, the computing power information of the target access network device may include one or more of the following information: a processor type of the target access network device, a processor capability of the target access network device, a processor occupancy status of the target access network device, a deployment status of a computing task on the target access network device, and the like. The computing power information of the first core network element includes one or more of the following information: a processor type of the first core network element, a processor capability of the first core network element, a processor occupancy status of the first core network element, a deployment status of a computing task on the first core network element, and the like.

In an embodiment a, that the CMF obtains the computing power information of the target access network device may be understood as follows: An SMF sends a computing power update request to the CMF. Correspondingly, the CMF receives the computing power update request from the SMF, where the computing power update request includes the computing power information of the target access network device. For example, the target access network device may send, to an AMF, a path switching request that carries the computing power information of the target access network device. Correspondingly, after receiving the path switching request from the target access network device, the AMF may encapsulate the computing power information of the target access network device in a computing session update request, and send the computing session update request to the SMF. Correspondingly, after receiving the computing session update request from the AMF, the SMF may send, to the CMF based on the computing power update request, the computing power information that is of the target access network device and that is carried in the computing session update request. In other words, the target access network device may send the path switching request to the AMF, where the path switching request includes the computing power information of the target access network device. Correspondingly, after receiving the path switching request from the target access network device, the AMF may send the computing session update request to the SMF, where the computing session update request includes the computing power information of the target access network device. Further, the SMF sends the computing power update request to the CMF, where the computing power update request includes the computing power information of the target access network device. Correspondingly, the CMF receives the computing power update request from the SMF, and performs computing power reconfiguration based on the computing power information of the target access network device in the computing power update request, as shown in operation S6011a to operation S6013a in FIG. 6A and FIG. 6B.

In another embodiment b, that the CMF obtains the computing power information of the target access network device may be understood as follows: An AMF sends a computing power update request to the CMF. Correspondingly, the CMF receives the computing power update request from the AMF, where the computing power update request includes the computing power information of the target access network device. For example, the target access network device may send, to the AMF, a path switching request that carries the computing power information of the target access network device. Correspondingly, after receiving the path switching request from the target access network device, the AMF may encapsulate the computing power information of the target access network device in the computing power update request, and directly send the computing power update request to the CMF. In other words, the target access network device may send the path switching request to the AMF, where the path switching request includes the computing power information of the target access network device. Correspondingly, after receiving the path switching request from the target access network device, the AMF may directly send the computing power update request to the CMF, where the computing power update request includes the computing power information of the target access network device, as shown in operation S6011b and operation S6012b in FIG. 6A and FIG. 6B.

It should be noted that, the first core network element described in this embodiment of this application may be any core network element having a computing capability, and there may be one or more first core network elements. This is not limited in this embodiment of this application. After obtaining the computing power information of the target access network device and the computing power information of the first core network element, the CMF may configure/reconfigure/delete and acknowledge the target access network device and the first core network element based on the computing power information and information such as CE deployment information of a first computing service. In some embodiments, the CMF may further perform computation of downlink AN tunnel information based on information such as the obtained computing power information and the CE deployment information of the first computing service, and in some cases, may further determine and/or configure and transmit uplink CN tunnel information.

S602: The CMF sends a CE configuration message to the target access network device based on the computing power information of the target access network device and the computing power information of the first core network element. Correspondingly, the target access network device receives the CE configuration message from the CMF.

S602′: The CMF sends a CE reconfiguration or deletion message to the first core network element based on the computing power information of the target access network device and the computing power information of the first core network element. Correspondingly, the first core network element receives the CE reconfiguration or deletion message from the CMF.

In some embodiments, the CMF may send a compute executor CE configuration message to the target access network device and send the CE reconfiguration or deletion message to the first core network element based on the computing power information of the target access network device and the computing power information of the first core network element, to perform computing power reconfiguration of a first computing task. The first computing task is a computing task originally executed on a source access network device. For example, the first computing task may be a task like AI inference or AI training. In some embodiments, the first computing task may alternatively be a task like AR or holography. This is not limited in this application.

After receiving the CE configuration message from the CMF, the target access network device may configure a CE based on information, such as a storage resource, electric quantity information, a memory resource, computing power, execution duration information, computing power model information, and/or split point information of a computing power model, that is included in the CE configuration message. After receiving the CE reconfiguration message from the CMF, the first core network element may reconfigure a CE based on information, such as a storage resource, electric quantity information, a memory resource, computing power, execution duration information, computing power model information, and/or split point information of a computing power model, that is included in the CE reconfiguration message. In some embodiments, if the CMF sends a deletion message, the first core network element may delete the CE based on information, such as a CE ID, that is included in the deletion message. In summary, the CMF may reconfigure/deploy/allocate computing power of the first computing task by sending a configuration, reconfiguration, or deletion message.

For example, assuming that the first computing task is executed on the first core network element and the source access network device, computation with 40% of computing power allocation is performed on the first core network element, and computation with 60% of computing power allocation is performed on the source access network device. Due to a cell handover, the CMF may reconfigure computing power allocation of the first computing task on different network elements based on the obtained computing power information of the target access network device and the obtained computing power information of the first core network element. For example, the CMF may allocate 50% of computation to be performed on the first core network element, and 50% of computation to be performed on the target access network device. For another example, assuming that the CMF determines, based on the computing power information of the first core network element, that a computing power resource of the first core network element is insufficient, the CMF may configure not to execute the computing task on the first core network element, but configure all of the first computing task to be performed on the target access network device.

S603: The target access network device sends an acknowledgment message for the CE configuration message to the CMF. Correspondingly, the CMF receives the acknowledgment message from the target access network device.

In some embodiments, after completing computing power configuration of the first computing task on the target access network device based on the received configuration message. the target access network device may feed back the acknowledgment message for the CE configuration message to the CMF.

S604: The first core network element sends an acknowledgment message for the CE reconfiguration or deletion message to the CMF. Correspondingly, the CMF receives the acknowledgment message from the first core network element.

In some embodiments, after completing computing power configuration of the first computing task on the first core network element based on the received CE reconfiguration or deletion message, the first core network element may feed back the acknowledgment message for the CE reconfiguration or deletion message to the CMF.

In some embodiments, after completing computing power reconfiguration, the CMF may further perform the following operations.

S605: The CMF sends a computing power reconfiguration result or computing session information corresponding to the computing power reconfiguration result.

The computing power reconfiguration result herein may also be described as a CE reconfiguration result. It should be understood that, in an embodiment a (as shown in operation S605 la to operation S6053a in FIG. 6A and FIG. 6B), the CMF may send a computing power update acknowledgment message to the SMF, where the computing power update acknowledgment message includes the computing session information corresponding to the computing power reconfiguration result. Correspondingly, after receiving the computing power update acknowledgment message from the CMF, the SMF may send a computing session update acknowledgment message to the AMF based on the computing power update acknowledgment message, where the computing session update acknowledgment message includes the computing session information. In some embodiments, after receiving the computing session update acknowledgment message from the SMF, the AMF may further send a path switching acknowledgment message to the target access network device based on the computing session update acknowledgment message, where the path switching acknowledgment message includes the computing session information. The computing session information includes information about a destination CE and type information of the destination CE.

In some embodiments, in another embodiment b (as shown in operation S6051b to operation S6054b in FIG. 6A and FIG. 6B), the CMF may send a computing session update request to the SMF. Correspondingly, after receiving the computing session update request from the CMF, the SMF may send a computing session update acknowledgment message to the CMF, where the computing session update acknowledgment message includes the computing session information corresponding to the computing power reconfiguration result. It may be understood that, based on the received computing power reconfiguration result, the SMF may determine some parameters, such as information about a destination CE and the type information of the destination CE, in the computing session information. Further, the CMF may send, to the AMF, a computing power update acknowledgment message that carries the computing session information. In some embodiments, after receiving the computing power update acknowledgment message from the CMF, the AMF may further send a path switching acknowledgment message to the target access network device, where the path switching acknowledgment message includes the computing session information.

It may be understood that, the type information of the destination CE includes a RAN type or a CN type, and information about a target CE may be a target CE identity (ID). The target CE ID may identify the target CE. The target CE herein is a CE for which a computing context needs to be released.

The computing power update request/acknowledgment message may also be understood as a manner for reconfiguring collaboration between a terminal device, the target access network device, and the first core network element.

S606: The target access network device releases a computing context of the source access network device and/or a computing context of the first core network element based on the computing session information.

It may be understood that, after receiving the path switching acknowledgment message from the AMF, the target access network device may release the computing context of the source access network device and/or the computing context of the first core network element based on the computing session information that is carried in the path switching acknowledgment message.

For example, if the type information of the destination CE in the computing session information is the CN type, the target access network device may release the computing context of the source access network device.

For another example, if the type information of the destination CE in the computing session information is the RAN type, the target access network device may release the computing context of the source access network device, and release the computing context of the first core network element.

In some embodiments, before operation S601, the following operations may be further included.

S6001: The source access network device sends a handover request to the target access network device. Correspondingly, the target access network device receives the handover request from the source access network device.

The handover request includes computing service indication information. For example, the computing service indication information includes information such as indication information of the first computing task, indication information of a service type, and indication information of a session type. It may be understood that, the indication information of the first computing task may be an ID or the like of the first computing task, the service type includes a stateful service or a stateless service, and the session type includes RAN termination or CN termination.

S6002: The target access network device performs access control based on the computing service indication information.

It may be understood that, the target access network device may perform access control based on information, such as the first computing task, the service type, and the session type, that is included in the computing service indication information. In some embodiments, in addition to the information such as the first computing task, the service type, and the session type, the target access network device may further perform access control based on computing service deployment information, a radio resource load status, and the like of the target access network device.

In some embodiments, after operation S6002, the following operation may be further included.

S6003: The target access network device sends a handover request acknowledgment message to the source access network device. Correspondingly, the source access network device receives the handover request acknowledgment message from the target access network device.

It may be understood that, the handover request acknowledgment message includes information, such as connection resource allocation and random access resource allocation, that is of the terminal device, so that the target access network device obtains a timing advance of the terminal device, to ensure clock synchronization between the terminal device and the target access network device. Further, the terminal device may perform a handover procedure of handing over from the source access network device to the target access network device, and then perform the foregoing operation S601 and subsequent operations after completing the handover procedure.

In this embodiment of this application, when the terminal device and the RAN and/or the CN collaborate to complete a computing task, if a cell handover occurs on the terminal device, the CMF may obtain the computing power information of the target access network device and the computing power information of the first core network element, and perform computing power redeployment based on the obtained computing power information, to migrate the computing task from the source access network device to the target access network device. According to the method provided in this application, computing migration is more flexibly implemented, and quality of service of the computing service and continuity of computing task execution can be ensured after the cell handover occurs on the terminal device in a computing collaboration scenario.

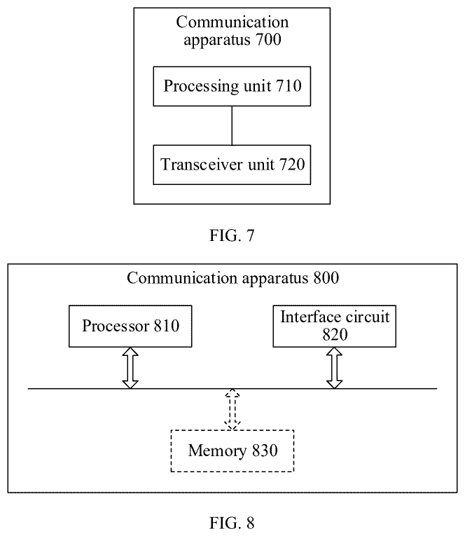

The following describes in detail the communication apparatus provided in this application with reference to FIG. 7 and FIG. 8.

It may be understood that, to implement functions in the foregoing embodiments, the communication apparatus includes corresponding hardware structures and/or corresponding software modules for performing the functions. A person skilled in the art should be easily aware that, with reference to units and method operations in examples described in embodiments disclosed in this application, this application can be implemented in a form of hardware or a combination of hardware and computer software. Whether a function is performed by hardware or hardware driven by computer software depends on application scenarios and design constraints of the technical solutions.

FIG. 7 and FIG. 8 are diagrams of structures of example communication apparatuses according to embodiments of this application. The communication apparatuses may be configured to implement functions of a CMF or an access network device (for example, a target access network device or a source access network device) in the foregoing method embodiment, and therefore can also achieve beneficial effects of the foregoing method embodiment. In embodiments of this application, the communication apparatus may alternatively be a module (for example, a chip) used in the CMF or the access network device.

As shown in FIG. 7, the communication apparatus 700 includes a processing unit 710 and a transceiver unit 720. The communication apparatus 700 is configured to implement a function of the CMF or the access network device in the method embodiment shown in FIG. 6A and FIG. 6B.

When the communication apparatus 700 is configured to implement the function of the CMF in the method embodiment shown in FIG. 6A and FIG. 6B, the transceiver unit 720 is configured to obtain computing power information of a target access network device and computing power information of a first core network element; the transceiver unit 720 is configured to: send a compute executor CE configuration message to the target access network device and send a CE reconfiguration or deletion message to the first core network element based on the computing power information of the target access network device and the computing power information of the first core network element, to perform computing power reconfiguration of a first computing task; and the transceiver unit 720 is configured to: receive an acknowledgment message for the CE configuration message from the target access network device, and receive an acknowledgment message for the CE reconfiguration or deletion message from the first core network element.

When the communication apparatus 700 is configured to implement the function of the target access network device in the method embodiment shown in FIG. 6A and FIG. 6B, the transceiver unit 720 is configured to send a path switching request to an access and mobility management function AMF, where the path switching request includes the computing power information of the target access network device; the transceiver unit 720 is configured to receive a compute executor CE configuration message from a computing management function CMF, where the CE configuration message is for configuring computing power of a first computing task on the target access network device; and the transceiver unit 720 is configured to send an acknowledgment message for the CE configuration message to the CMF.

In some embodiments, the transceiver unit 720 is further configured to: receive a handover request from a source access network device, where the handover request includes computing service indication information, and the computing service indication information is for performing access control by the target access network device.

In some embodiments, the processing unit 710 may be configured to release a computing context of the source access network device and/or a computing context of the first core network element.

For more detailed descriptions of the processing unit 710 and the transceiver unit 720, refer to related descriptions in the method embodiment shown in FIG. 6A and FIG. 6B.

As shown in FIG. 8, the communication apparatus 800 includes a processor 810 and an interface circuit 820. The processor 810 and the interface circuit 820 are coupled to each other. It may be understood that, the interface circuit 820 may be a transceiver or an input/output interface. In some embodiments, the communication apparatus 800 may further include a memory 830, configured to: store instructions to be executed by the processor 810, store input data required by the processor 810 to run the instructions, or store data generated after the processor 810 runs the instructions.

When the communication apparatus 800 is configured to implement the method shown in FIG. 6A and FIG. 6B, the processor 810 is configured to implement a function of the foregoing processing unit 710, and the interface circuit 820 is configured to implement a function of the foregoing transceiver unit 720.

When the communication apparatus is a chip used in a CMF, the chip in the CMF implements a function of the CMF in the foregoing method embodiment. The chip in the CMF receives, via another module (for example, a radio frequency module or an antenna) in the CMF, information sent by an access network device to the CMF. Alternatively, the chip in the CMF sends information to another module (for example, a radio frequency module or an antenna) in the CMF, where the information is sent by the CMF to an access network device.

When the communication apparatus is a module used in an access network device (for example, a target access network device), the module in the access network device implements a function of the access network device in the foregoing method embodiment. The module in the access network device receives information from another module (for example, a radio frequency module or an antenna) in the access network device, where the information is sent by the CMF to the access network device. Alternatively, the module in the access network device sends information to another module (for example, a radio frequency module or an antenna) in the access network device, where the information is sent by the access network device to the CMF. The module in the access network device herein may be a baseband chip in the access network device. or may be a CU, a DU, or another module; or may be an apparatus in an open radio access network (O-RAN) architecture, for example, an apparatus like an open CU or an open DU.

It may be understood that, the processor in embodiments of this application may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or any conventional processor.

Method operations in embodiments of this application may be implemented in hardware, or may be implemented in software instructions that may be executed by a processor. The software instructions may include corresponding software modules. The software modules may be stored in a random access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well known in the art. For example, a storage medium is coupled to a processor, to enable the processor to read information from the storage medium and write information into the storage medium. The storage medium may alternatively be a component of the processor. The processor and the storage medium may be located in an ASIC. In addition, the ASIC may be located in an access network device or a CMF. The processor and the storage medium may alternatively exist in an access network device or a CMF as discrete components.

All or some of the foregoing embodiments may be implemented by using software, hardware, firmware, or any combination thereof. When software is used for implementing the embodiments, all or some of the embodiments may be implemented in a form of a computer program product. The computer program product includes one or more computer programs or instructions. When the computer programs or the instructions are loaded and executed on a computer, all or some of procedures or functions in embodiments of this application are performed. The computer may be a general-purpose computer, a dedicated computer, a computer network, a network device, user equipment, or another programmable apparatus. The computer programs or the instructions may be stored in a computer-readable storage medium, or may be transmitted from a computer-readable storage medium to another computer-readable storage medium. For example, the computer programs or the instructions may be transmitted from a website, a computer, a server, or a data center to another website, computer, server, or data center in a wired or wireless manner. The computer-readable storage medium may be any usable medium accessible by a computer, or a data storage device, such as a server or a data center, integrating one or more usable media. The usable medium may be a magnetic medium, for example, a floppy disk, a hard disk, or a magnetic tape: or may be an optical medium, for example, a digital video disc: or may be a semiconductor medium, for example, a solid-state drive. The computer-readable storage medium may be a volatile or non-volatile storage medium, or may include two types of storage media: a volatile storage medium and a non-volatile storage medium.

In embodiments of this application, unless otherwise specified or there is a logical conflict, terms and/or descriptions in different embodiments are consistent and may be mutually referenced, and technical features in different embodiments may be combined based on an internal logical relationship thereof, to form a new embodiment.

It may be understood that, various numbers in embodiments of this application are merely used for differentiation for ease of description, but are not used for limiting the scope of embodiments of this application. Sequence numbers of the foregoing processes do not mean execution sequences. The execution sequences of the processes should be determined based on functions and internal logic of the processes.

1. A method of configuring computing power, the method comprising:
obtaining computing power information of a target access network device and computing power information of a first core network element;
sending a compute executor (CE) configuration message to the target access network device;
sending a CE reconfiguration or deletion message to the first core network element based on the computing power information of the target access network device and the computing power information of the first core network element, to perform computing power reconfiguration of a first computing task;
receiving an acknowledgment message for the CE configuration message from the target access network device; and
receiving an acknowledgment message for the CE reconfiguration or deletion message from the first core network element.

2. The method according to claim 1, wherein obtaining the computing power information of the target access network device comprises:
receiving a computing power update request from a session management function (SMF), wherein the computing power update request comprises the computing power information of the target access network device; or
receiving a computing power update request from an access and mobility management function AMF, wherein the computing power update request comprises the computing power information of the target access network device.

3. The method according to claim 2, wherein the method further comprises:
sending a computing power update acknowledgment message to the SMF, wherein the computing power update acknowledgment message comprises computing session information corresponding to a computing power reconfiguration result, the computing session information comprises information about a destination CE and type information of the destination CE, and the computing session information is for releasing a computing context of a source access network device and/or a computing context of the first core network element; or
sending a computing power update acknowledgment message to the AMF, wherein the computing power update acknowledgment message comprises computing session information corresponding to a computing power reconfiguration result, the computing session information.

4. The method according to claim 3, wherein the type information of the destination CE comprises a radio access network (RAN) type or a core network (CN) type.

5. The method according to claim 1, wherein the computing power information of the target access network device comprises at least one of: a processor type of the target access network device, a processor capability of the target access network device, a processor occupancy status of the target access network device, or a deployment status of a computing task on the target access network device; and
the computing power information of the first core network element comprises at least one of: a processor type of the first core network element, a processor capability of the first core network element, a processor occupancy status of the first core network element, and a deployment status of a computing task on the first core network element.

6. A method of computing power reconfiguration, the method comprising:
sending a path switching request to an access and mobility management function (AMF), wherein the path switching request comprises computing power information of a target access network device;
receiving a compute executor (CE) configuration message from a computing management function (CMF), wherein the CE configuration message is for configuring computing power of a first computing task on the target access network device; and
sending an acknowledgment message for the CE configuration message to the CMF.

7. The method according to claim 6, wherein the method further comprises:
receiving a path switching acknowledgment message from the AMF, wherein the path switching acknowledgment message comprises computing session information corresponding to a computing power reconfiguration result, and the computing session information comprises information about a destination CE and type information of the destination CE; and
releasing a computing context of a source access network device and/or a computing context of a first core network element based on the computing session information.

8. The method according to claim 7, wherein the type information of the destination CE comprises a radio access network (RAN) type or a core network (CN) type.

9. The method according to claim 7, wherein the method further comprises:
receiving a handover request from the source access network device, wherein the handover request comprises computing service indication information, and the computing service indication information is for performing access control by the target access network device.

10. The method according to claim 9, wherein the computing service indication information comprises indication information of the first computing task, indication information of a service type, and indication information of a session type.

11. The method according to claim 10, wherein the service type comprises a stateful service or a stateless service, and the session type comprises radio access network RAN termination or core network CN termination.

12. An apparatus, comprising:
a processor configured to obtain computing power information of a target access network device and compute power information of a first core network element; and
an interface circuit configured to:
send a compute executor (CE) configuration message to the target access network device; and
send a CE reconfiguration or deletion message to the first core network element based on the computing power information of the target access network device and the computing power information of the first core network element, to perform computing power reconfiguration of a first computing task;
receive an acknowledgment message for the CE configuration message from the target access network device; and
receive an acknowledgment message for the CE reconfiguration or deletion message from the first core network element.

13. The apparatus according to claim 12, wherein obtain the computing power information of the target access network device comprises:
receive a computing power update request from a session management function (SMF), wherein the compute power update request comprises the compute power information of the target access network device; or
receive a computing power update request from an access and mobility management function AMF, wherein the compute power update request comprises the compute power information of the target access network device.

14. The apparatus according to claim 13, wherein further comprises:
send a computing power update acknowledgment message to the SMF, wherein the compute power update acknowledgment message comprises computing session information corresponding to a computing power reconfiguration result, the computing session information comprises information about a destination CE and type information of the destination CE, and the computing session information is for releasing a computing context of a source access network device and/or a computing context of the first core network element; or
send a computing power update acknowledgment message to the AMF, wherein the computing power update acknowledgment message comprises computing session information corresponding to a computing power reconfiguration result, the computing session information comprises information about a destination CE and type information of the destination CE, and the computing session information is for releasing a computing context of a source access network device and/or a computing context of the first core network element.

15. The apparatus according to claim 14, wherein the type information of the destination CE comprises a radio access network (RAN) type or a core network (CN) type.

16. The apparatus according to claim 12, wherein the computing power information of the target access network device comprises at least one of: a processor type of the target access network device, a processor capability of the target access network device, a processor occupancy status of the target access network device, or a deployment status of a computing task on the target access network device; and
the computing power information of the first core network element comprises at least one of: a processor type of the first core network element, a processor capability of the first core network element, a processor occupancy status of the first core network element, and a deployment status of a computing task on the first core network element.
